(19) United States
(12) Patent Application Publication
(10) Pub. No.: US 2024/0338496 A1
(43) Pub. Date: Oct. 10, 2024

(54) METHOD FOR PROVIDING CONSECUTIVE ROW UNIFORM LEVEL MOUNTING HEIGHTS IN A SOLAR FIELD

(71) Applicant: Inventus Holdings, LLC, Juno Beach, FL (US)

(72) Inventors: TIMOTHY D. STOVALL, KINGSTON, TN (US); LAUREN A. FOLEY, WEST PALM BEACH, FL (US); KRISTEN BRADFORD, ROSEMOUNT, MN (US); TIMOTHY R. BATTAGLIA, JUPITER, FL (US); SHANE M. BUFFINGTON, JUPITER, FL (US)

(21) Appl. No.: 18/474,684

(22) Filed: Sep. 26, 2023

Related U.S. Application Data
(60) Provisional application No. 63/495,204, filed on Apr. 10, 2023.

(51) Int. Cl. G06F 30/13; H02S 99/00

(52) U.S. Cl. CPC G06F 30/13; H02S 99/00; G06F 2113/04

(57) ABSTRACT

A method for generating a solar field layout includes receiving terrain parameters correspond to topographical data associated with a geographical region of interest on which a prospective solar field is to be built, and receiving engineering tolerance parameters associated with installation height of a torque tube of a prospective row of solar panels. A solar panel row layout profile is generated for each prospective row of the prospective solar field based on the topographical data and based on the engineering tolerance parameters. The solar panel row layout profile of each prospective row of a plurality of rows is aggregated to determine a common level mounting height of the torque tube across each of consecutive prospective rows of solar panels to generate a solar panel row group. A solar field design corresponding to the prospective solar field is generated to include a plurality of solar panel row groups.

### RELATED APPLICATIONS

This application claims priority from U.S. Patent Application Ser. No. 63/495,204, filed 10 Apr. 2023, which is incorporated herein by reference in its entirety.

### TECHNICAL FIELD

This disclosure relates generally to solar power systems, and more specifically to a method for providing consecutive row uniform level mounting heights in a solar field.

### BACKGROUND

Renewable and natural energy sources are becoming more popular for generating power. Such renewable and natural energy sources are persistently available, require no fuel, generate no pollutants, and are more widely accepted in a more ecologically conscientious society. Such renewable and natural energy sources can be scaled to a great extent to provide renewable power plants. One such renewable power plant is a solar field (i.e., solar farm) that harnesses a large amount of solar energy to generate electricity for a public power grid to provide clean and renewable energy to a community. A solar field can be implemented as a large-scale photovoltaic system that includes a large number of photovoltaic modules (i.e., solar panels) arranged in series to convert light directly to electricity. By utilizing a very large number of solar panels, a solar field can supply power at a utility level, rather than to a local user or users based on building-mounted and other decentralized solar power applications. Furthermore, a solar field can implement solar tracking, such that the solar panels are rotated as the Sun moves across the sky to optimize capture of the solar energy.

### SUMMARY

One example includes a method for generating a solar field layout. The method includes receiving terrain parameters correspond to topographical data associated with a geographical region of interest on which a prospective solar field is to be built, and receiving engineering tolerance parameters associated with installation height of a torque tube of a prospective row of solar panels. A solar panel row layout profile is generated for each prospective row of the prospective solar field based on the topographical data and based on the engineering tolerance parameters. The solar panel row layout profile of each prospective row of a plurality of rows is aggregated to determine a common level mounting height of the torque tube across each of consecutive prospective rows of solar panels to generate a solar panel row group. A solar field design corresponding to the prospective solar field is generated to include a plurality of solar panel row groups.

Another example includes a computer system. The system includes a user interface configured to facilitate inputs and to provide outputs with respect to a user. The system also includes a memory configured to store terrain parameters corresponding to topographical data associated with a geographical region of interest on which a prospective solar field is to be built, engineering tolerance parameters associated with installation height of a torque tube of a prospective row of solar panels, and a solar field design corresponding to the prospective solar field and generated via the inputs provided via the user interface, the solar field design comprising a plurality of solar panel row groups. The system also includes a processor configured to execute a solar panel layout algorithm. The solar panel layout algorithm can be configured to generate a solar panel row layout profile for each prospective row of the prospective solar field based on the topographical data and based on the engineering tolerance parameters, and iteratively aggregate the solar panel row layout profile of each prospective row of multiple consecutive prospective rows of solar panels to determine a common level mounting height of the torque tube across each of the consecutive prospective rows of solar panels to generate each of the solar panel row groups.

Another example includes a non-transitory computer readable medium comprising machine-readable instructions. The machine-readable instructions can be executed to store terrain parameters correspond to topographical data associated with a geographical region of interest on which a prospective solar field is to be built in a memory, and to store engineering tolerance parameters associated with installation height of a torque tube of a prospective row of solar panels in the memory. The machine-readable instructions can also be executed to generate a solar panel row layout profile for each prospective row of the prospective solar field based on the topographical data and based on the engineering tolerance parameters, and to iteratively aggregate the solar panel row layout profile of each prospective row of multiple consecutive prospective rows of solar panels to determine a common level mounting height of the torque tube across each of the consecutive prospective rows of solar panels to generate a solar panel row group. The machine-readable instructions can be further executed to generate a solar field design corresponding to the prospective solar field. The solar field design can include a plurality of solar panel row groups and can be stored in the memory.

### BRIEF DESCRIPTION OF THE DRAWINGS

FIG. 1 illustrates an example of a utility power system.

FIG. 2 illustrates an example diagram of a portion of a solar field.

FIG. 3 illustrates an example block diagram of a computer system configured to implement a solar panel layout algorithm.

FIG. 4 illustrates an example of a solar panel row layout profile.

FIG. 5 illustrates an example diagram of multiple solar panel row layout profiles.

FIG. 6 illustrates an example diagram of aggregated solar panel row layout profiles.

FIG. 7 illustrates another example diagram of a portion of a solar field.

FIG. 8 illustrates an example of a method for generating a solar field layout.

### DETAILED DESCRIPTION

This disclosure relates generally to solar power systems, and more specifically to a method for providing consecutive row uniform level mounting heights in a solar field. The system can be provided as a solar panel layout algorithm that is implemented in conjunction with or within a solar field design that is configured to design a solar field on a geographic region of interest on which a solar field is to be built. The solar panel layout algorithm can be configured to provide a layout of the solar panels such that consecutive rows of solar panels can be mounted approximately level with each other with respect to a torque tube along the row within one of a set of solar panel row groups in the solar field. As described herein, the term “level” refers to an approximately equal height of the torque tubes of each of the rows of solar panels along the entirety of the length of each of the rows relative to each other, regardless of differences in elevation of the terrain on which the torque tubes are mounted from row-to-row. The equal height does not necessarily mean level in three-dimensional space (e.g., tangent to the surface of Earth), but that the torque tubes have an equal slope and are equal height relative to a level virtual plane that is common to all of the rows, thereby forming a virtual plane (e.g., the torque tubes are coplanar). In this manner, the post heights that mount the torque tubes can be variable at each individual location to ensure that the torque tubes are coplanar when installed on uneven ground.

The computer system on which the solar panel layout algorithm is implemented can receive topographical data associated with the geographical region of interest and engineering tolerance parameters associated with installation height of the torque tubes of the rows of solar panels of the prospective solar field. As an example, the topographical data can be received via digital terrain and elevation data (DTED), such as provided by a geological data service, or can be generated from overhead imaging (e.g., via satellite or aerial drone imaging, or via light detection and ranging (LIDAR)). The engineering tolerance parameters can be associated with dimensions of the mounting poles on which the torque tubes are installed, as well as associated mounting dimensions. The engineering parameters can thus include a maximum mounting depth in the ground to facilitate the capability of solar tracking rotation of the torque tube, and thus the solar panels mounted thereon, and a minimum mounting depth to facilitate sufficient stability of the mounting to protect from erosion, wind, or other natural phenomena.

The solar panel layout algorithm can thus be configured to generate a solar panel row layout profile for each row of the prospective solar field based on the topographical data and the engineering tolerance parameters. As an example, the solar panel row layout profile can include a tolerance window that is bounded by a minimum and a maximum mounting height of the torque tube across the prospective row, and thus defines a range of acceptable mounting heights of the torque tube across the prospective row. The tolerance window can thus accommodate a linear fit-line corresponding to a potential elevation of the torque tube across the prospective row. The solar panel layout algorithm can thus be configured to aggregate the solar panel row layout profile of each of prospective multiple rows to determine a common level mounting height of the torque tube across each of consecutive prospective rows of solar panels to generate a solar panel row group.

For example, the aggregation of the solar panel row layout profiles can be based on overlaying the solar panel row layout profiles to aggregate the tolerance window based on overlapping of the maximum and minimum mounting heights. The solar panel layout algorithm can thus determine if the linear fit-line can still be provided across the entirety of the consecutive rows of solar panels without intersection with the boundaries of the aggregated tolerance window. If the linear fit-line can be provided without intersection with the boundaries of the aggregated tolerance window, then the rows represented by the aggregated solar panel row layout profiles can correspond to a solar panel row group. Thus, the solar field design corresponding to the prospective solar field can be generated to include a plurality of solar panel row groups.

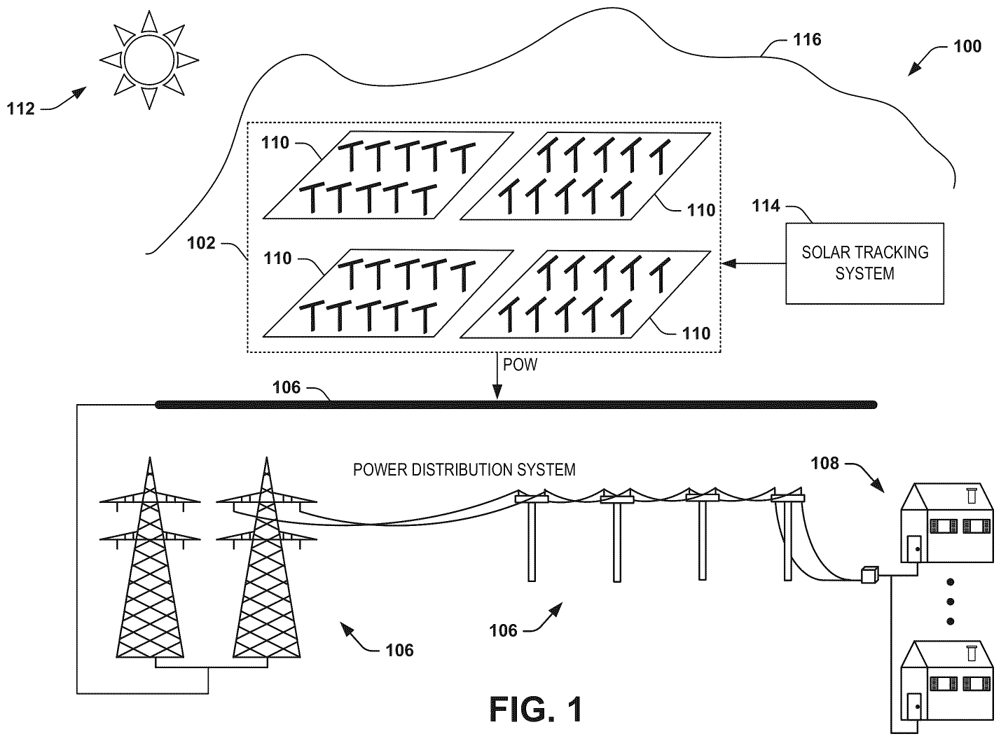

A solar power system that can be built based on a solar field design described herein can be implemented in any of a variety of utility power systems, such as demonstrated in the example of FIG. 1. FIG. 1 illustrates an example of a utility power system 100. The utility power system 100 includes at least one power generator system 102 that is configured to provide power, demonstrated in the example of FIG. 1 as POW, to a power transmission system 104. The power transmission system 104 can correspond to a power bus or one or more points-of-interconnect (POIs) that provide power via a power distribution system 106 (e.g., transformers, substations, and power lines) to consumers, demonstrated generally at 108. In the example of FIG. 1, the power generator system(s) 102 are demonstrated as solar power generator system(s) that include sets of solar panels 110 configured to generate the power POW via the Sun, demonstrated at 112.

In the example of FIG. 1, the power generator system(s) 102 includes a solar tracking system 114 that is configured to implement a solar tracking control scheme for the solar panels 110. The solar tracking control scheme can be such that a motor or servo can control rotation of a torque tube on which the solar panels are arranged, such that the solar panels can be oriented to face the Sun 112 over the course of a day. As an example, a solar field that includes the solar panels 110 can be installed on complex terrain (e.g., hills or uneven terrain), demonstrated generally at 116, which can result in shadows cast from a solar panel in one row to a corresponding solar panel in a next row at more extreme angles of the rotation of the solar panels 110. Such shadowing of neighboring panels can be mitigated by backtracking, in which the extremes of the rotation of the torque tubes, and thus the solar panels, can be limited to prevent shadows from being cast on neighboring solar panels in a next row of solar panels.

However, in a typical solar panel layout, the complex terrain can provide for a more uneven arrangement of the solar panels along a given row relative to a next row. The effects of such uneven terrain can result in a worst-case-scenario of the backtracking of a row of solar panels (e.g., very limited rotation extremes of the torque tube of a row of solar panels) relative to a next row of solar panels based on disparity of the height of the solar panels in and along a given row relative to the solar panels in and along a next consecutive row based on long shadows cast in the mornings and evenings. Therefore, as described herein, a solar panel layout algorithm can be implemented to provide for grouping of solar panel rows in a solar panel design that allows for even mounting of the solar panels along a group of rows of solar panels based on providing the torque tubes of all of the rows in the solar panel row group in a planar arrangement (e.g., in that the torque tubes of all of the rows of solar panels in the solar panel row group form a plane).

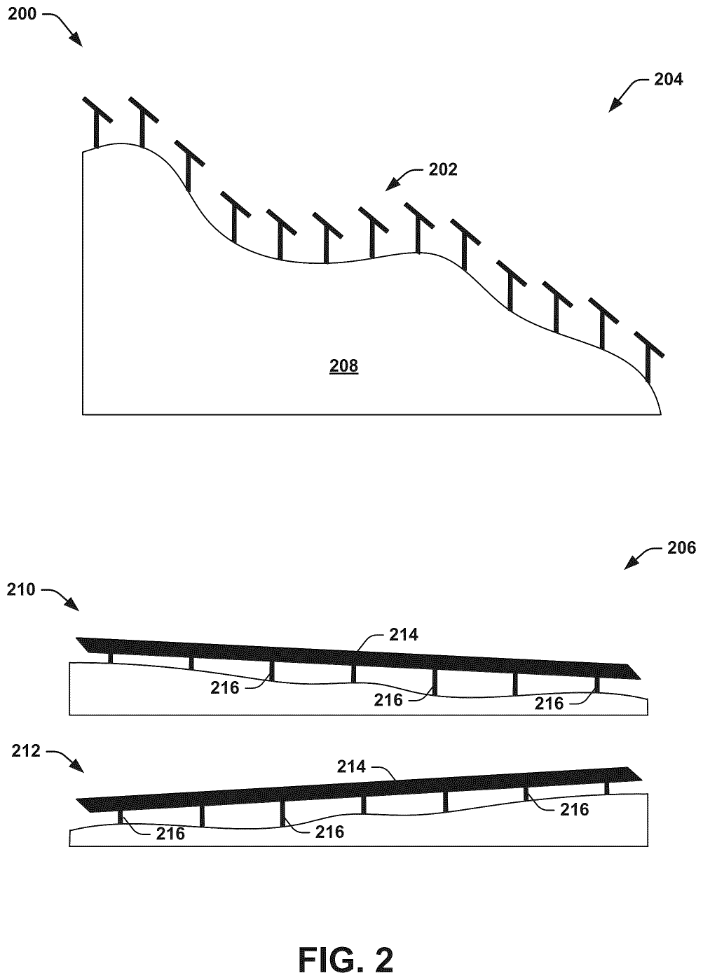

FIG. 2 illustrates an example diagram 200 of a portion of a solar field. The diagram 200 includes a solar field 202 that is demonstrated in a first view 204 and a second view 206. The diagram 200 can correspond to the solar field that includes the solar panels 110 in the example of FIG. 1. Therefore, reference is to be made to the example of FIG. 1 in the following description of the example of FIG. 2.

In the first view 204, the solar field 202 is demonstrated simplistically as being built on uneven terrain, demonstrated generally at 208. In the example of FIG. 2, the solar field 202 is demonstrated two-dimensionally as single solar panels that are each part of a row of solar panels extending into and/or out of the page of FIG. 2. The solar panels of the solar field 202 can be directed at an angle that allows for rays of the Sun to be incident on the solar panels at approximately normal angles, thereby optimizing the capture of solar energy from the Sun. As the Sun moves across the sky, the solar tracking scheme of the solar field 202 can provide for the solar panels to follow the position of the Sun by rotating the torque tube on which the solar panels in a given row are mounted, thus attempting to maintain the approximate normal angle of incidence of the rays of the Sun on the solar panels.

Because the solar field 202 is built on uneven terrain, a given solar panel of a given row can have a different elevation relative to the solar panels in each of the neighboring rows to the east and west. Based on the difference in row-to-row height of the solar panels of the solar field 202 and based on the row-to-row spacing of the solar panels of the solar field 202, the angle of tilt of the solar panels during the course of the day can result in a shadow being cast upon the surface of a corresponding solar panel in a next row, particularly in the mornings and evenings. Therefore, the solar tracking scheme can implement backtracking to limit the extreme positions of rotation of the torque tubes on which the solar panels of a given row can move, thus mitigating shadows cast from solar panels of a given row on a solar panel of a next consecutive row. While limiting solar capture efficiency, backtracking may thus be highly necessary for solar tracking schemes of the solar field 202 to mitigate the highly inefficient or even inoperable conditions resulting from shadows on solar panels, but can be even less efficient for solar fields built upon uneven terrain 208. However, while backtracking mitigates shadows being cast from solar panels in one row onto solar panels of a neighboring row, particularly in the mornings and evenings, limiting the rotation extremes of the solar panels still reduces solar capture efficiency based on increasing the angle of incidence of the rays of the Sun relative to normal.

The second view 206 demonstrates a first row 210 of solar panels and a second row 212 of solar panels. The rows 210 and 212 are demonstrated as stand-alone with respect to each other, and can thus each correspond to one of the rows of the solar panels in the solar field 202 in the first view 204. The rows 210 and 212 are each demonstrated as including a table of solar panels 214 mounted on a torque tube (not shown) that extends across the entirety of the respective rows 210 and 212. The torque tubes can be mounted on mounting poles 216 that are driven into the ground to provide the height of the solar panels 214, such as within an acceptable height range.

The second view 206 demonstrates that the uneven ground 208 can affect not only the row-to-row disparity in height of the solar panels in the solar field 202, but also a disparity in height across a given row. In the example of FIG. 2, the first row 210 is demonstrated as sloping slightly downward from left to right, while the second row 212 is demonstrated as sloping slightly upward from left to right. The difference in height profiles across the first and second rows 210 and 212 can result in unintended shadows cast on solar panels in next consecutive rows, similar to as described with respect to the row-to-row height differences of the uneven terrain 208 in the first view 204.

Particularly, as an example, the first and second rows 210 and 212 can be consecutive rows, with the first row 210 being to the east of the second row 212, and can be approximately equal in mounting height at an approximate center of the rows 210 and 212. In this example, the leftmost side of the first row 210 in the second view 206 could cast a shadow on the leftmost side of the second row 212 in the morning based on the height of the leftmost side of the first row 210 being higher than the height of the leftmost side of the second row 212. Similarly, the rightmost side of the second row 212 in the second view 206 could cast a shadow on the rightmost side of the first row 210 in the evening based on the height of the rightmost side of the second row 212 being higher than the height of the rightmost side of the second row 210. Therefore, despite the height of the first and second rows 210 and 212 being approximately equal at the middle of the respective rows 210 and 212, the uneven terrain across the respective rows 210 and 212 might still necessitate backtracking in the solar tracking scheme of the solar field 202.

A typical solar field can be constructed based on engineering tolerances associated with the mounting poles 216 and row-to-row distance between the rows of solar panels. For example, the engineering tolerances can dictate a minimum height and a maximum height of the solar panels. As an example, the maximum height of the solar panels can be defined such that a mounting pole 216 be required to be driven into the ground sufficiently deep to provide for structural integrity, such that the row of solar panels can remain intact despite the effects of natural phenomena, such as erosion and wind. However, the minimum height of the solar panels can be defined such that a mounting pole 216 be required to be driven into the ground not so deep as to incur shadows from vegetation or to provide a collision of the ends of the solar panels with the ground resulting based on the rotation of the solar panel about the torque tube. Thus, for conventional installation of solar fields, the engineering mounting tolerances of the mounting poles 216 are the only consideration given for the physical mounting of the rows of the solar field 202 in the ground. Accordingly, backtracking is even more inefficient for mitigating shadowing for a conventional solar field on uneven terrain 208 relative to backtracking that is implemented on a relative flat terrain.

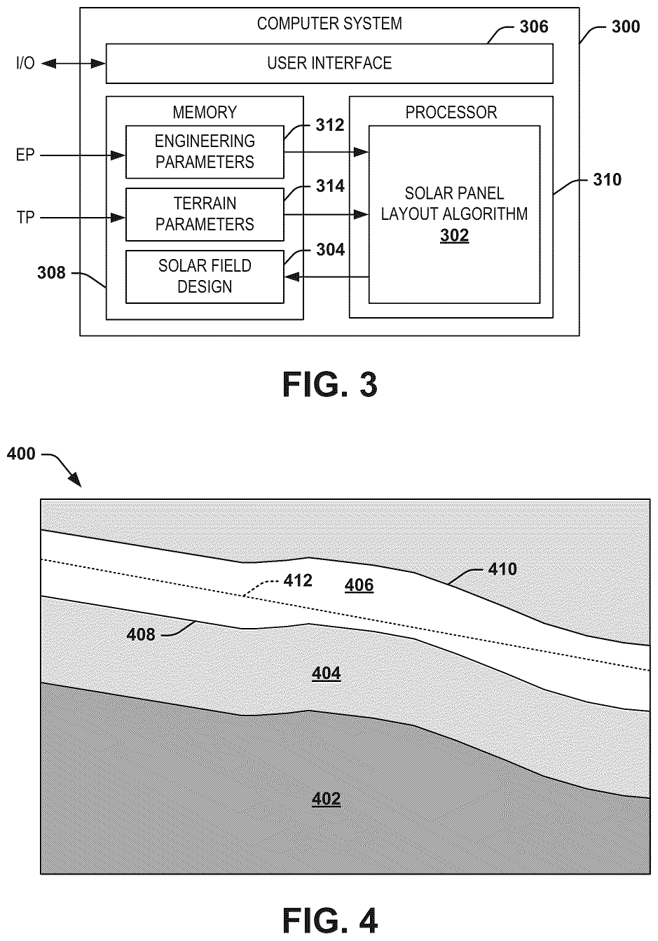

As described herein, the solar panel layout algorithm can provide for a manner of generating a solar field design in which the rows of solar panels are installed in a manner that allows for more efficient backtracking on uneven terrain by improving the row-to-row worst-case scenario based on an improved row-to-row solar panel geometry. FIG. 3 illustrates an example block diagram of a computer system 300 configured to implement a solar panel layout algorithm 302. As described in greater detail herein, the solar panel layout algorithm 302 can be implemented to generate a solar field design 304 that can provide solar panel row groups, each including one or more rows of solar panels, in which backtracking resulting from installation on uneven terrain may be obviated within a given one of the solar panel row groups.

The computer system 300 includes a user interface 306 that can facilitate inputs and outputs I/O from and to a user. Thus, the computer system 300 can correspond to a personal computer, enterprise computer, tablet computer, dedicated terminal, or any of a variety of computer devices. The computer system 300 also includes a memory 308 and a processor 310. The memory 308 is demonstrated as being configured to store the solar field design 304. Additionally, the computer system 300 is demonstrated as receiving inputs EP corresponding to engineering parameters 312 that are stored in the memory 308, and as receiving inputs TP corresponding to terrain parameters 314 that are stored in the memory 308. While the engineering parameters 312 and the terrain parameters 314 are demonstrated as being provided as separate inputs, the engineering parameters 312 and the terrain parameters 314 could also be input as part of the inputs of the I/O via the user interface 306.

The engineering parameters 312 can correspond to design considerations and constraints associated with the solar field design 304, such as dimensional considerations of the solar panels, such as a row-to-row spacing and dimensions of the solar panels and associated tracking system. The engineering parameters 312 can also include engineering tolerance parameters that are associated with a height of the torque tubes of the rows of the prospective solar field, such as corresponding to a mounting height of the mounting poles (e.g., the mounting poles 216) on which the torque tubes are mounted. For example, the engineering tolerance parameters in the engineering parameters 312 can define a maximum mounting height and a minimum mounting height of the torque tubes of a given row of solar panels based on a length of the mounting poles.

The terrain parameters 314 can correspond to topographical data associated with a geographical region of interest on which a prospective solar field is to be built. For example, the topographical data defined by the terrain parameters 314 can be received via digital terrain and elevation data (DTED), such as provided by a geological data service. As another example, the topographical data can be provided from overhead imaging, such as generated via satellite images, LIDAR, or from aerial drone imaging. The terrain parameters 314 can thus provide the specific elevations of the uneven terrain on which the prospective solar field is to be built.

The processor 310 is thus configured to implement the solar panel layout algorithm 302. The solar panel layout algorithm 302 can be configured to generate a solar panel row layout profile for each row of the prospective solar field based on the topographical data and the engineering tolerance parameters. As an example, the solar panel row layout profile can be generated as a two-dimensional graphical representation of a cross-section of the portion of the prospective solar field on which a given one row of solar panels is installed. The solar panel row layout profile can include a two-dimensional terrain portion, a minimum mounting offset region, and a tolerance window. The two-dimensional terrain portion can correspond to a cross-section of the terrain (e.g., ground) on which the row of solar panels is to be installed. The minimum mounting offset region can correspond to a portion of the solar panel row layout profile that is bounded by the two-dimensional terrain portion and a first line corresponding to the minimum acceptable mounting height of the torque tube. The tolerance window can define a range of acceptable mounting heights of the torque tube across the prospective row, and is thus bounded by the first line corresponding to the minimum acceptable mounting height and a second line corresponding to the maximum acceptable mounting height.

FIG. 4 illustrates an example of a solar panel row layout profile 400. The solar panel row layout profile 400 can be generated for each row in the prospective solar field, as described herein. The solar panel row layout profile 400 is demonstrated in the example of FIG. 4 in a graphical representation. However, the solar panel row layout profile 400 can instead merely correspond to two-dimensional coordinate array data in the memory 308, such that the example of FIG. 4 merely provides a graphical representation of the solar panel row layout profile 400 for case of demonstration.

The solar panel row layout profile 400 includes a two-dimensional terrain portion 402, a minimum mounting offset region 404, and a tolerance window 406. As described above, the two-dimensional terrain portion 402 can correspond to a cross-section of the terrain (e.g., ground) on which the row of solar panels is to be installed. The two-dimensional terrain portion 402 can be generated based on the topographical data provided in the terrain parameters 314, and thus the elevation of the terrain across the prospective row. The minimum mounting offset region 404 can correspond to a portion of the solar panel row layout profile 400 that is bounded by the two-dimensional terrain portion 402 and a first line 408 corresponding to the minimum acceptable mounting height. The minimum acceptable mounting height can be provided in the engineering tolerance parameters defined by the engineering parameters 312. Thus the first line 408 corresponding to the minimum acceptable mounting height of the torque tube is merely a constant offset from the elevation of the terrain across the prospective row.

The tolerance window 406 can define a range of acceptable mounting heights of the torque tube across the prospective row. The tolerance window 406 is bounded by the first line 408 and a second line 410 corresponding to the maximum acceptable mounting height of the torque tube, such as to maintain stability of the mounting of the torque tube. Therefore, the torque tube can be mounted at any height between the first and second lines 408 and 410. Accordingly, the tolerance window 406 can be configured to accommodate a linear fit-line 412 that corresponds to a potential elevation of the torque tube across the prospective row. As long as the linear fit-line 412 can be provided across the tolerance window 406 without intersecting either of the first and second lines 408 and 410, the torque tube can be mounted in the acceptable dimensions provided by the tolerance window 406 in the solar panel row layout profile 400.

As described above, the solar panel layout algorithm 302 is configured to generate a solar panel row layout profile for each of the rows of the prospective solar field. The solar panel layout algorithm 302 can then be configured to aggregate some of the solar panel row layout profiles of consecutive prospective rows to determine a common level mounting height of the torque tube across each of consecutive prospective rows of solar panels to generate a solar panel row group. In this manner, the height of each of the torque tubes across each of the rows in the solar panel row group can be approximately level across the entirety of the rows. Accordingly, backtracking of the solar tracking scheme of the solar panels in each of the rows in a given solar panel row group can be more efficient for solar capture of the Sun's rays over the course of a day.

To aggregate some of the solar panel row layout profiles of consecutive rows, the solar panel layout algorithm 302 can begin with a first solar panel row layout profile (e.g., the solar panel row layout profile 400), and can iteratively overlay additional solar panel row layout profiles, one at a time, corresponding to next consecutive prospective rows of solar panels. At each iteratively added solar panel row layout profile, an aggregated tolerance window can be generated based on an overlap of the lines defining the minimum and maximum mounting heights of the torque tubes (e.g., the first and second lines 408 and 410). The solar panel layout algorithm 302 can then determine if the linear fit-line can be provided across the entirety of the aggregated tolerance window without intersecting the lines defining the minimum and maximum mounting heights of the torque tubes which bound the aggregated tolerance window. If the linear fit-line can be provided across the aggregated tolerance window without intersection, then the solar panel layout algorithm 302 can iteratively add an additional solar panel row layout profile and repeat the process indefinitely (e.g., across any number of rows so long as the linear fit-line can continue to be drawn on each given iteration). If the linear fit-line cannot be provided across the aggregated tolerance window without intersection, then the solar panel layout algorithm 302 removes the most recently added solar panel row layout profile and generates a solar panel row group that includes the linear fit-line across only the previous iterations (e.g., prior to the most recent solar panel row layout profile that was added then removed). The solar panel layout algorithm 302 can then begin the process again with a first solar panel row layout profile corresponding to the next consecutive row of solar panels.

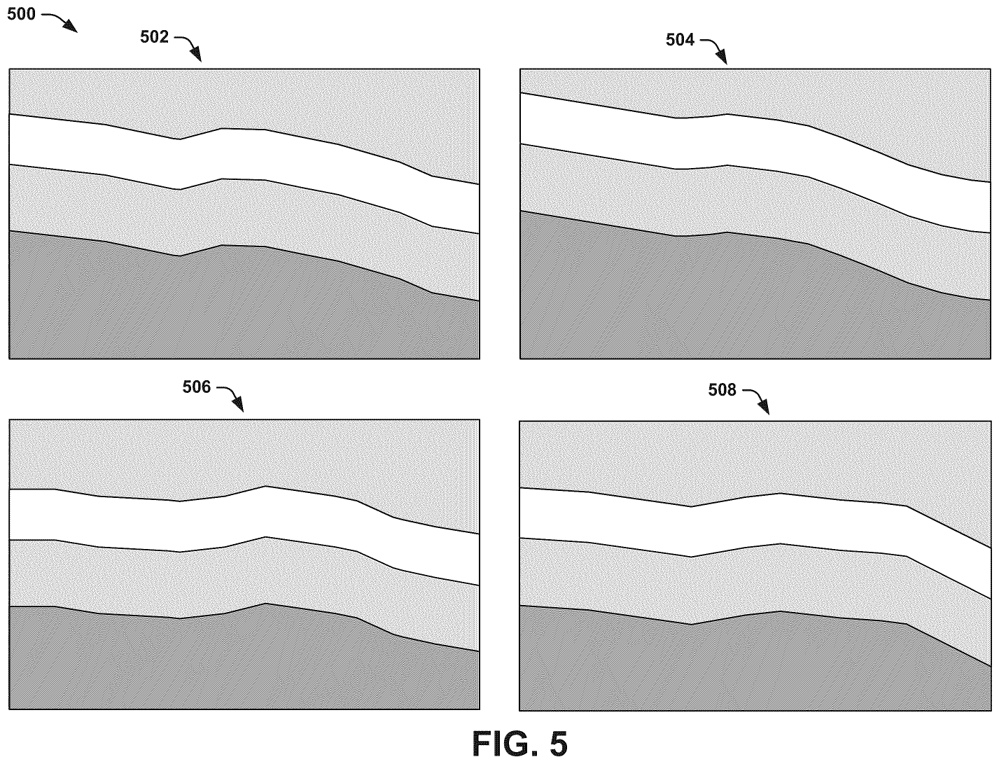

FIG. 5 illustrates an example diagram 500 of multiple solar panel row layout profiles. The diagram 500 includes a first solar panel row layout profile 502, a second solar panel row layout profile 504, a third solar panel row layout profile 506, and a fourth solar panel row layout profile 508. The first solar panel row layout profile 502 can correspond to the solar panel row layout profile 400 in the example of FIG. 4. The second solar panel row layout profile 504 can correspond to a solar panel row layout profile of the next consecutive prospective row of solar panels after the first solar panel row layout profile 502, the third solar panel row layout profile 506 can correspond to a solar panel row layout profile of the next consecutive prospective row of solar panels after the second solar panel row layout profile 504, and the fourth solar panel row layout profile 508 can correspond to a solar panel row layout profile of the next consecutive prospective row of solar panels after the third solar panel row layout profile 506. Each of the solar panel row layout profiles 502, 504, 506, and 508 include a two-dimensional terrain profile, a minimum mounting offset region, and a tolerance window, similar to as described in the example of FIG. 4.

As described above, the solar panel layout algorithm 302 can iteratively overlay solar panel row layout profiles, one at a time, corresponding to next consecutive prospective rows of solar panels, and generate an aggregated tolerance window. For example, the solar panel layout algorithm 302 can begin with the first solar panel row layout profile 502, then overlay the second solar panel row layout profile 504 over the first solar panel row layout profile 502 to generate an aggregated tolerance window. The aggregated tolerance window can thus only include portions of the tolerance windows in each of the first and second solar panel row layout profiles 502 and 504 that overlap. As a result, the aggregated tolerance window can be smaller than the tolerance windows of the respective first and second solar panel row layout profiles 502 and 504 based on the portions of the tolerance window of one of the first and second solar panel row layout profiles 502 and 504 that extend beyond the first and second lines that define the tolerance window of the respective other one of the first and second solar panel row layout profiles 502 and 504.

As described herein, the term “overlay” can correspond to combining the data associated with the respective solar panel row layout profiles. As a first example, the overlay can be graphical, such that the two-dimensional representations of the solar panel row layout profiles can be overlayed to generate a two-dimensional representation of the aggregated tolerance window. As another example, the overlay can be based on a canceling algorithm of corresponding locations in a data array. For example, the canceling algorithm can identify the portions corresponding to the tolerance windows of the respective solar panel row layout profiles and assign a logic-one binary value to the locations (e.g., coordinates) in a corresponding representative two-dimensional array. Therefore, the canceling algorithm can perform a logic AND operation of the corresponding matched locations in the two-dimensional array to generate the aggregated tolerance window.

After providing the overlay of the second solar panel row layout profile 504 onto the first solar panel row layout profile 502, the solar panel layout algorithm 302 can then determine if a linear fit-line can be provided across the entirety of the aggregated tolerance window without intersecting the lines which bound the aggregated tolerance window, which thus define the minimum and maximum mounting heights of the torque tubes along both of the corresponding rows of solar panels. As an example, to determine if the linear fit-line can be drawn without intersecting the solar panel layout algorithm 302 can iteratively begin at one location at one end of the aggregated tolerance window and can draw lines to all of the locations at the other end of the aggregated tolerance window. If any of the lines do not intersect the lines that bound the aggregated tolerance window, the solar panel layout algorithm 302 can select one as the linear fit-line and proceed with the next step of the algorithm. If all of the lines intersect the lines that bound the aggregated tolerance window, the solar panel layout algorithm 302 can select a new location at the one end of the aggregated tolerance window and can again draw lines to all of the locations at the other end of the aggregated tolerance window. The solar panel layout algorithm 302 can iteratively continue to do draw the lines until one of the lines reaches the other end without intersection, thereby determining a linear fit-line, or until a determination that no lines can be drawn without intersection, thereby determining that there is no possible linear fit-line that does not intersect.

If the linear fit-line can be provided across the aggregated tolerance window without intersection, then the solar panel layout algorithm 302 adds the third solar panel row layout profile 506 to the aggregated first and second solar panel row layout profiles 502 and 504 (e.g., to the combined overlay of the first and second solar panel row layout profiles 502 and 504). The solar panel layout algorithm 302 thus generates another aggregated tolerance window based on the overlay of the tolerance window of the third solar panel row layout profile 506 on the aggregated tolerance window of the first and second solar panel row layout profiles 502 and 504. If the linear fit-line cannot be provided across the aggregated tolerance window of the first and second solar panel row layout profiles 502 and 504, then the solar panel layout algorithm 302 defines the row corresponding to the first solar panel row layout profile 502 as a solar panel row group (e.g., a group of one, in this example). The solar panel layout algorithm 302 can thus dictate that the linear fit-line corresponds to the mounting height of the torque tube for the row of solar panels for the respective solar panel row group in the solar field design 304. Then the solar panel layout algorithm 302 begins the algorithm again by beginning with the second solar panel row layout profile 504 and overlays the third solar panel row layout profile 506 onto the second solar panel row layout profile 504, similar to as described above.

In the event that the solar panel layout algorithm 302 adds the third solar panel row layout profile 506 to the aggregated first and second solar panel row layout profiles 502 and 504, after providing the overlay of the third solar panel row layout profile 506 onto the aggregated first and second solar panel row layout profiles 502 and 504, the solar panel layout algorithm 302 can then determine if the linear fit-line can again be provided across the entirety of the aggregated tolerance window without intersecting the lines which bound the aggregated tolerance window. If the linear fit-line can be provided across the aggregated tolerance window without intersection, then the solar panel layout algorithm 302 adds the fourth solar panel row layout profile 508 to the aggregated first, second, and third solar panel row layout profiles 502, 504, and 506 (e.g., to the combined overlay of the first, second, and third solar panel row layout profiles 502, 504, and 506). The solar panel layout algorithm 302 thus generates another aggregated tolerance window based on the overlay of the tolerance window of the fourth solar panel row layout profile 508 on the aggregated tolerance window of the first, second, and third solar panel row layout profiles 502, 504, and 506. If the linear fit-line cannot be provided across the aggregated tolerance window of the first, second, and third solar panel row layout profiles 502, 504, and 506, then the solar panel layout algorithm 302 defines the rows corresponding to the first and second solar panel row layout profiles 502 and 504 as a solar panel row group. The solar panel layout algorithm 302 can thus dictate that the linear fit-line corresponds to the mounting height of the torque tube for the two consecutive rows of solar panels for the respective solar panel row group in the solar field design 304. Then the solar panel layout algorithm 302 begins the algorithm again by beginning with the third solar panel row layout profile 506 and overlays the fourth solar panel row layout profile 508 onto the third solar panel row layout profile 506, similar to as described above.

In the event that the solar panel layout algorithm 302 adds the fourth solar panel row layout profile 508 to the aggregated first, second, and third solar panel row layout profiles 502, 504, and 506, after providing the overlay of the fourth solar panel row layout profile 508 onto the aggregated first, second, and third solar panel row layout profiles 502, 504, and 506, the solar panel layout algorithm 302 can then determine if the linear fit-line can again be provided across the entirety of the aggregated tolerance window without intersecting the lines which bound the aggregated tolerance window.

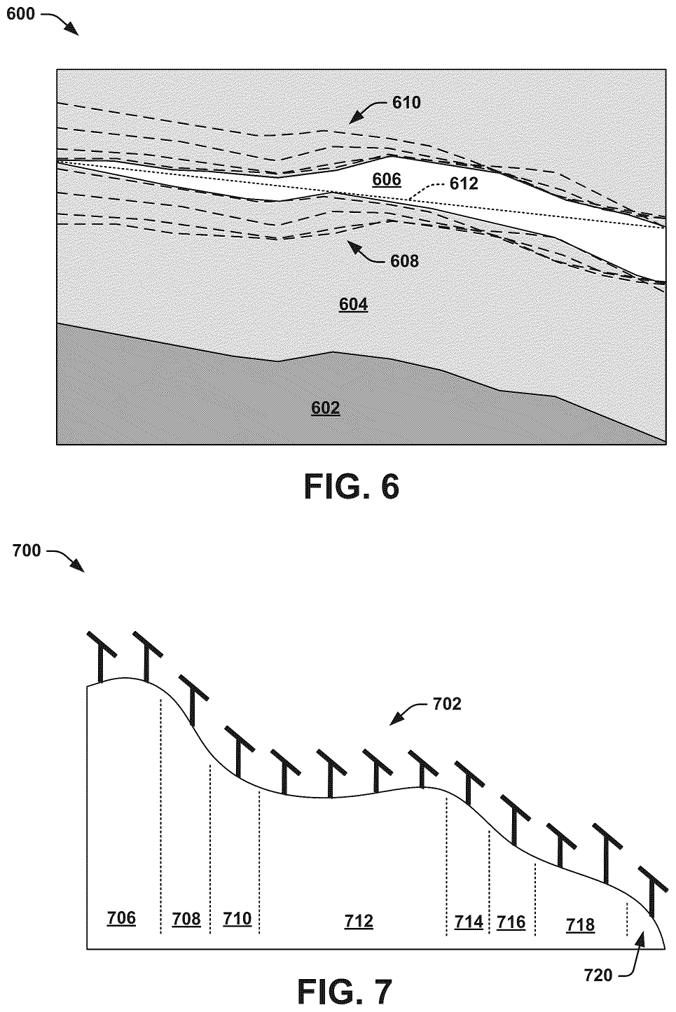

FIG. 6 illustrates an example diagram of an aggregate solar panel row layout profile 600. The aggregate solar panel row layout profile 600 is thus demonstrated as a graphical overlay of the first, second, third, and fourth solar panel row layout profiles 502, 504, 506, and 508. The aggregate solar panel row layout profile 600 includes an aggregate two-dimensional terrain portion 602, an aggregate minimum mounting offset region 604, and an aggregated tolerance window 606. The aggregated tolerance window 606 can thus correspond to a portion of the aggregate solar panel row layout profile 600 in which the tolerance windows of all four of the solar panel row layout profiles 502, 504, 506, and 508 overlap completely. In the example of FIG. 6, the first and second lines that bound the individual tolerance windows of the respective solar panel row layout profiles 502, 504, 506, and 508 are demonstrated generally at 608 and 610, respectively. Therefore, the aggregated tolerance window 606 is diminished in size relative to the individual tolerance windows of the respective solar panel row layout profiles 502, 504, 506, and 508 based on an overlap of the first and second lines into the individual tolerance windows of at least one of other the solar panel row layout profiles 502, 504, 506, and 508.

As described above, the solar panel layout algorithm 302 can determine if the linear fit-line can be provided across the entirety of the aggregated tolerance window 606 without intersecting the lines which bound the aggregated tolerance window 606. In the example of FIG. 6, a linear fit-line 612 is demonstrated as extending across the entirety of the aggregated tolerance window 606. Therefore, as described above, the solar panel layout algorithm 302 can add a fifth solar panel row layout profile to overlay the aggregate solar panel row layout profile 600 and can repeat the above process of generating another aggregated tolerance window. As an example, the solar panel layout algorithm 302 can determine that a linear fit-line cannot be drawn across the aggregated tolerance window of the fifth solar panel row layout profile on the aggregate solar panel row layout profile 600. Accordingly, the solar panel layout algorithm 302 defines the rows corresponding to the solar panel row layout profiles 502, 504, 506, and 508 as a solar panel row group. The solar panel layout algorithm 302 can thus dictate that the linear fit-line 612 corresponds to the mounting height of the torque tube for all four consecutive rows of solar panels corresponding to the solar panel row layout profiles 502, 504, 506, and 508 in the respective solar panel row group in the solar field design 304. While the examples of FIGS. 5 and 6 demonstrate iterative aggregation of four solar panel row layout profiles, a given iterative aggregation process for determining the mounting height of the torque tube can involve aggregation of fewer than or more than four aggregated solar panel row layout profiles, as described herein.

As a result of implementing the solar panel layout algorithm 302, the solar field design 304 can provide for leveling of rows of solar panels in each of the solar panel row groups. FIG. 7 illustrates an example diagram 700 of a portion of a solar field that was installed based on the solar field design 304 resulting from operation of the solar panel layout algorithm 302. The diagram 700 includes a solar field 702 that is demonstrated simplistically as being built on uneven terrain, demonstrated generally at 704. In the example of FIG. 7, the solar field 702 is demonstrated two-dimensionally as single solar panels that are each part of a row of solar panels extending into and/or out of the page of FIG. 7.

Based on the operation of the solar panel layout algorithm 302, the solar field 702 is demonstrated as including separate solar panel row groups. Particularly, the solar field 702 includes a first solar panel row group 706, a second solar panel row group 708, a third solar panel row group 710, a fourth solar panel row group 712, a fifth solar panel row group 714, a sixth solar panel row group 716, a seventh solar panel row group 718, and an eighth solar panel row group 720. The first solar panel row group 706 includes two rows of solar panels, such that the torque tubes of each of the two rows have a mounting height that is level at all locations across the two rows, and are thus coplanar. The second and third panel row groups 708 and 710 include only a single row each. Therefore, the solar panel layout algorithm 302 can have determined that a linear fit-line could not be drawn without intersecting the bounding lines of an aggregated tolerance window of the solar panel row layout profiles associated with the rows in the first panel row group 706 and the row in the second panel row group 708, the aggregated tolerance window of the solar panel row layout profiles associated with the rows in the second and third panel row groups 708 and 710, or the aggregated tolerance window of the solar panel row layout profiles associated with the row in the third panel row group 710 and the first row in the fourth panel row group 712.

The fourth solar panel row group 712 includes four rows of solar panels, such that the torque tubes of each of the four rows have a mounting height that is level, and thus coplanar, at all locations across the four rows. The fifth and sixth panel row groups 714 and 716 include only a single row each. Therefore, the solar panel layout algorithm 302 can have determined that a linear fit-line could not be drawn without intersecting the bounding lines of an aggregated tolerance window of the solar panel row layout profiles associated with the rows in the fourth panel row group 712 and the row in the fifth panel row group 714, the aggregated tolerance window of the solar panel row layout profiles associated with the rows in the fifth and sixth panel row groups 714 and 716, or the aggregated tolerance window of the solar panel row layout profiles associated with the row in the sixth panel row group 716 and the first row in the seventh panel row group 718. The seventh solar panel row group 718 includes two rows of solar panels, such that the torque tubes of each of the two rows have a mounting height that is level, and thus coplanar, at all locations across the two rows. The eighth solar panel row group 720 includes only a single row, and thus could not be combined with the rows in the seventh panel row group 718 based on a determination that a linear fit-line could not be drawn in the associated aggregated tolerance window of the associated solar panel row layout profiles of the rows in the seventh panel row group 718 and the row in the eighth panel row group 720.

As described above, based on the leveling of the torque tubes of the rows of solar panels in the solar panel row groups that include more than one solar panel (e.g., the first, fourth, and seventh solar panel row groups 706, 712, and 718), backtracking can be more efficient in the solar tracking scheme for the rows of solar panels in the respective solar panel row groups 706, 712, and 718. Therefore, the solar field 702 can provide for more efficient capture of solar energy on the rows of the solar panels (e.g., the solar field 202 in the example of FIG. 2). Accordingly, by implementing the solar panel layout algorithm 302, the solar field design 304 can result in construction of a more energy efficient solar field on uneven terrain than a typical solar field constructed on uneven terrain.

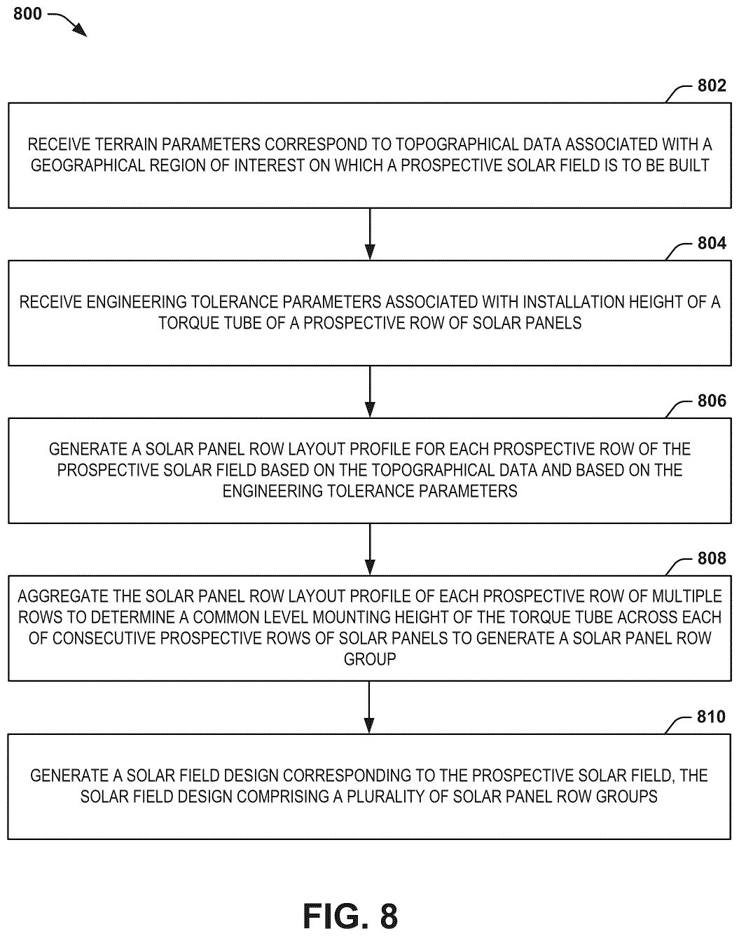

In view of the foregoing structural and functional features described above, a methodology in accordance with various aspects of the present invention will be better appreciated with reference to FIG. 8. While, for purposes of simplicity of explanation, the methodology of FIG. 8 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect of the present invention.

FIG. 8 illustrates an example of a method 800 for generating a solar field layout. At 802, terrain parameters (e.g., the terrain parameters 314) corresponding to topographical data associated with a geographical region of interest on which a prospective solar field is to be built are received. At 804, engineering tolerance parameters (e.g., the engineering parameters 312) associated with installation height of a torque tube of a prospective row of solar panels are received. At 806, a solar panel row layout profile (e.g., the solar panel row layout profile 400) for each prospective row of the prospective solar field is generated based on the topographical data and based on the engineering tolerance parameters. At 808, the solar panel row layout profile of each prospective row of a plurality of rows are aggregated (e.g., the aggregated solar panel row layout profile 600) to determine a common level mounting height of the torque tube across each of consecutive prospective rows of solar panels to generate a solar panel row group (e.g., one of the solar panel row groups 706, 708, 710, 712, 714, 716, 718, and 720). At 810, a solar field design corresponding to the prospective solar field is generated. The solar field design can include a plurality of solar panel row groups.

What have been described above are examples of the disclosure. It is, of course, not possible to describe every conceivable combination of components or method for purposes of describing the disclosure, but one of ordinary skill in the art will recognize that many further combinations and permutations of the disclosure are possible. Accordingly, the disclosure is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A method for generating a solar field layout, the method comprising:
receiving terrain parameters corresponding to topographical data associated with a geographical region of interest on which a prospective solar field is to be built;
receiving engineering tolerance parameters associated with installation height of a torque tube of a prospective row of solar panels;
generating a solar panel row layout profile for each prospective row of the prospective solar field based on the topographical data and based on the engineering tolerance parameters;
aggregating the solar panel row layout profile of each prospective row of a plurality of rows to determine a common level mounting height of the torque tube across each of consecutive prospective rows of solar panels to generate a solar panel row group; and
generating a solar field design corresponding to the prospective solar field, the solar field design comprising a plurality of solar panel row groups.

2. The method of claim 1, wherein generating the solar panel row layout profile for each prospective row of the prospective solar field comprises generating the solar panel row layout profile comprising a tolerance window across the prospective row based on the topographical data and the engineering tolerance parameters, the tolerance window defining a range of acceptable mounting heights of the torque tube across the prospective row.

3. The method of claim 2, wherein the tolerance window is configured to accommodate a linear fit-line corresponding to a potential elevation of the torque tube across the prospective row.

4. The method of claim 2, wherein the tolerance window is bounded by a minimum acceptable mounting height relative to an elevation of the geographical region of interest along the prospective row, as defined by the topographical data, and a maximum acceptable mounting height, as defined by the engineering tolerance parameters.

5. The method of claim 4, wherein generating a solar panel row layout profile for each prospective row of the prospective solar field comprises generating a two-dimensional representation of the solar panel row layout profile, the two-dimensional representation of the solar panel row layout profile comprising a two-dimensional terrain portion, a minimum mounting offset region bounded by the two-dimensional terrain portion and a first line corresponding to the minimum acceptable mounting height, and the tolerance window bounded by the first line corresponding to the minimum acceptable mounting height and a second line corresponding to the maximum acceptable mounting height.

6. The method of claim 4, wherein aggregating the solar panel row layout profile of each prospective row of a plurality of rows comprises:
providing a first solar panel row layout profile of a first prospective row;
overlaying a second solar panel row layout profile of a second prospective row corresponding to a next consecutive prospective row over the first solar panel row layout profile to generate an aggregate solar panel row layout profile;
generating an aggregated tolerance window based on an overlap of the minimum and maximum acceptable mounting heights of the first and second solar panel row layout profiles on the tolerance window of each of the first and second solar panel row layout profiles; and
determining whether a linear fit-line corresponding to a potential elevation of the torque tube across each of the first and second prospective rows can be drawn across the aggregated tolerance window without intersection with the minimum and maximum acceptable mounting heights of the first and second solar panel row layout profiles bounding the aggregated tolerance window.

7. The method of claim 6, wherein aggregating the solar panel row layout profile of each prospective row of the plurality of rows further comprises generating the solar panel row group comprising only the first prospective row in response to a determination that the linear fit-line cannot be drawn across the aggregated tolerance window without intersection.

8. The method of claim 6, wherein aggregating the solar panel row layout profile of each prospective row of the plurality of rows further comprises:
iteratively overlaying another solar panel row layout profile corresponding to a next consecutive prospective row over the aggregate solar panel row layout profile to further aggregate the other solar panel row layout profile with the aggregate solar panel row layout profile in response to a determination that the linear fit-line can be drawn across the aggregated tolerance window without intersection; and
generating a further aggregated tolerance window based on the overlap of the minimum and maximum acceptable mounting heights of the next solar panel row layout profiles on the aggregated tolerance window in response to the determination that the non-intersecting linear fit-line can be drawn across the aggregated tolerance window without intersection.

9. The method of claim 8, wherein aggregating the solar panel row layout profile of each prospective row of the plurality of rows further comprises generating the solar panel row group comprising the first and second prospective rows in response to a determination that the linear fit-line cannot be drawn across the aggregated tolerance window without intersection.

10. The method of claim 1, wherein receiving terrain parameters comprises storing the terrain parameters in a memory, wherein receiving engineering tolerance parameters comprises storing the engineering tolerance parameters in the memory, and wherein generating the solar field design comprises storing the solar field design in the memory.

11. A computer system comprising:
a user interface configured to facilitate inputs and to provide outputs with respect to a user;
a memory configured to store:
terrain parameters corresponding to topographical data associated with a geographical region of interest on which a prospective solar field is to be built;
engineering tolerance parameters associated with installation height of a torque tube of a prospective row of solar panels; and
a solar field design corresponding to the prospective solar field and generated via the inputs provided via the user interface, the solar field design comprising a plurality of solar panel row groups; and
a processor configured to execute a solar panel layout algorithm, the solar panel layout algorithm being configured to:
generate a solar panel row layout profile for each prospective row of the prospective solar field based on the topographical data and based on the engineering tolerance parameters; and
iteratively aggregate the solar panel row layout profile of each prospective row of a plurality of consecutive prospective rows of solar panels to determine a common level mounting height of the torque tube across each of the consecutive prospective rows of solar panels to generate each of the solar panel row groups.

12. The system of claim 11, wherein the solar panel layout algorithm is configured to generate the solar panel row layout profile to include a tolerance window across the prospective row based on the topographical data and the engineering tolerance parameters, the tolerance window defining a range of acceptable mounting heights of the torque tube across the prospective row and being configured to accommodate a linear fit-line corresponding to a potential elevation of the torque tube across the prospective row.

13. The system of claim 12, wherein the tolerance window is bounded by a minimum acceptable mounting height relative to an elevation of the geographical region of interest along the prospective row, as defined by the topographical data, and a maximum acceptable mounting height, as defined by the engineering tolerance parameters, wherein the solar panel layout algorithm is configured to generate a two-dimensional representation of the solar panel row layout profile, the two-dimensional representation of the solar panel row layout profile comprising a two-dimensional terrain portion, a minimum mounting offset region bounded by the two-dimensional terrain portion and a first line corresponding to the minimum acceptable mounting height, and the tolerance window bounded by the first line corresponding to the minimum acceptable mounting height and a second line corresponding to the maximum acceptable mounting height.

14. The system of claim 13, wherein the solar panel layout algorithm is configured to:
provide a first solar panel row layout profile of a first prospective row;
overlay a second solar panel row layout profile of a second prospective row corresponding to a next consecutive prospective row over the first solar panel row layout profile to generate an aggregate solar panel row layout profile;
generate an aggregated tolerance window based on an overlap of the minimum and maximum acceptable mounting heights of the first and second solar panel row layout profiles on the tolerance window of each of the first and second solar panel row layout profiles; and
determine whether the linear fit-line corresponding to the potential elevation of the torque tube across each of the first and second prospective rows can be drawn across the aggregated tolerance window without intersection with the minimum and maximum acceptable mounting heights of the first and second solar panel row layout profiles bounding the aggregated tolerance window.

15. The system of claim 14, wherein the solar panel layout algorithm is configured to:
iteratively overlay another solar panel row layout profile corresponding to a next consecutive prospective row over the aggregate solar panel row layout profile to further aggregate the other solar panel row layout profile with the aggregate solar panel row layout profile with the aggregated solar panel row layout profile in response to a determination that the linear fit-line can be drawn across the aggregated tolerance window without intersection;
generate an aggregated tolerance window based on the overlap of the minimum and maximum acceptable mounting heights of the next solar panel row layout profiles on the aggregated tolerance window in response to the determination that the non-intersecting linear fit-line can be drawn across the aggregated tolerance window without intersection; and
generate a solar panel row group comprising the first and second prospective rows in response to a determination that the linear fit-line cannot be drawn across the aggregated tolerance window without intersection.

16. A non-transitory computer readable medium comprising machine-readable instructions, the machine-readable instructions being executed to:
store terrain parameters correspond to topographical data associated with a geographical region of interest on which a prospective solar field is to be built in a memory;
store engineering tolerance parameters associated with installation height of a torque tube of a prospective row of solar panels in the memory;
generate a solar panel row layout profile for each prospective row of the prospective solar field based on the topographical data and based on the engineering tolerance parameters;
iteratively aggregate the solar panel row layout profile of each prospective row of multiple consecutive prospective rows of solar panels to determine a common level mounting height of the torque tube across each of the consecutive prospective rows of solar panels to generate a solar panel row group; and
generate a solar field design corresponding to the prospective solar field, the solar field design comprising a plurality of solar panel row groups and being stored in the memory.

17. The medium of claim 16, wherein the machine-readable instructions are executed to generate the solar panel row layout profile comprising a tolerance window across the prospective row based on the topographical data and the engineering tolerance parameters, the tolerance window defining a range of acceptable mounting heights of the torque tube across the prospective row and being configured to accommodate a linear fit-line corresponding to a potential elevation of the torque tube across the prospective row.

18. The medium of claim 17, wherein the tolerance window is bounded by a minimum acceptable mounting height relative to an elevation of the geographical region of interest along the prospective row, as defined by the topographical data, and a maximum acceptable mounting height, as defined by the engineering tolerance parameters, wherein the machine-readable instructions are executed to generate a two-dimensional representation of the solar panel row layout profile, the two-dimensional representation of the solar panel row layout profile comprising a two-dimensional terrain portion, a minimum mounting offset region bounded by the two-dimensional terrain portion and a first line corresponding to the minimum acceptable mounting height, and the tolerance window bounded by the first line corresponding to the minimum acceptable mounting height and a second line corresponding to the maximum acceptable mounting height.

19. The medium of claim 18, wherein the machine-readable instructions are executed to:
provide a first solar panel row layout profile of a first prospective row;
overlay a second solar panel row layout profile of a second prospective row corresponding to a next consecutive prospective row over the first solar panel row layout profile to generate an aggregate solar panel row layout profile;
generate an aggregated tolerance window based on an overlap of the minimum and maximum acceptable mounting heights of the first and second solar panel row layout profiles on the tolerance window of each of the first and second solar panel row layout profiles; and
determine whether the linear fit-line corresponding to the potential elevation of the torque tube across each of the first and second prospective rows can be drawn across the aggregated tolerance window without intersection with the minimum and maximum acceptable mounting heights of the first and second solar panel row layout profiles bounding the aggregated tolerance window.

20. The medium of claim 19, wherein the machine-readable instructions are executed to:
iteratively overlay another solar panel row layout profile corresponding to a next consecutive prospective row over the aggregate solar panel row layout profile to further aggregate the other solar panel row layout profile with the aggregate solar panel row layout profile in response to a determination that the linear fit-line can be drawn across the aggregated tolerance window without intersection;
generate an aggregated tolerance window based on the overlap of the minimum and maximum acceptable mounting heights of the next solar panel row layout profiles on the aggregated tolerance window in response to the determination that the non-intersecting linear fit-line can be drawn across the aggregated tolerance window without intersection; and
generate the solar panel row group comprising the first and second prospective rows in response to a determination that the linear fit-line cannot be drawn across the aggregated tolerance window without intersection.
